(19) United States
(12) Patent Application Publication
(10) Pub. No.: US 2019/0309196 A1
(43) Pub. Date: Oct. 10, 2019

(54) ACRYLIC ADHESIVE FORMULATION AND PROCESS FOR THE USE THEREOF

(71) Applicant: Illinois Tool Works Inc., Glenview, IL (US)

(72) Inventors: Philip L. Canale, Danvers, MA (US); Nicholas Geoffrey Caldarone, Danvers, MA (US)

(21) Appl. No.: 16/296,892

(22) Filed: Mar. 8, 2019

Related U.S. Application Data
(60) Provisional application No. 62/654,591, filed on Apr. 9, 2018.

(51) Int. Cl. C09J 133/10; C09J 133/08; C09J 11/08

(52) U.S. Cl. CPC C09J 133/10; C08F 2/48; C09J 11/08; C09J 133/08

(57) ABSTRACT

A curable two-part acrylate or methacrylate based structural adhesive composition for bonding a variety of substrates is provided that has an adhesive part A and an activator part B. Each of the part A and the part B having a separate storage stability of at least 165 days at 23° C. An additive is present to modify working time that has limited effect on fixture time, the additive being at least one of: a sulfonyl chloride in Part A, an encapsulated sulfonyl chloride in Part B, a halogen transfer agent in Part B, a multifunctional chain transfer agent in Part B, or a combination of any of the aforementioned. A process of applying an adhesive to a substrate is also provided.

### RELATED APPLICATIONS

This application claims priority benefit of U.S. Provisional Application Ser. No. 62/654,591 filed 9 Apr. 2018, the contents of which are hereby incorporated by references.

### FIELD OF THE INVENTION

The present invention in general relates to adhesives and in particular, to free-radical curing adhesives able to adhere to a variety of substrates and having a shelf stability of more than 165 days at 23° C.

### BACKGROUND OF THE INVENTION

In many industries, manufacturers of mated components have changed to structural adhesives to replace conventional fastening techniques such as rivets, bolts, and welding. Adhesives in theory offer many attractive properties that include improved product performance, aesthetics, some reduced overall assembly time, and lower production costs. Additionally, adhesives preclude much of the stress point concentration, corrosion, and component damage often seen with rivets, bolts, welding, and other traditional fastening methods. Adhesives have made considerable progress in lowering assembly times versus some traditional mechanical fastening methods but depending on the application and assembly time can still suffer from detrimental effects due to work life of the adhesive. In many applications, if the assembly has not been completed before the material becomes a hard or gelled solid, the adhesive joint will not offer the strength needed to perform as designed. In many instances if this happens it can lead to expensive and time-consuming reworking costs. To mitigate these problems manufacturers can go to a material with longer work life. However, in proceeding this way the material will take a longer time to become of sufficient strength to move to the next step in an assembly which is known as “fixture time.” Typically, for adhesives, as the work life is increased the fixture time can increase dramatically.

A sufficient strength to move to the next step in the production process is known as the fixture time for an adhesive. The adhesive strength to move to another stage in a production process is problematic since it is very much dependent on the specifics of the production process and the product. Most often, bond strengths to a metal joint are used to define adhesive strength. American standard test method, ASTM D1002, “Standard Test Method for Apparent Shear Strength of Single-Lap-Joint Adhesively Bonded Metal Specimens by Tension Loading (Metal-to-Metal)” is a well-accepted standard for testing adhesive strength. Fixture time can be defined as the time of the adhesive to reach a defined adhesive strength.

Typically, acrylic adhesives are used in applications where fixture time or time until the part can be handled is critical in a production or repair. Fixture time can typically be improved by accelerating the adhesive with a catalyst, increasing curing agent, or reducing agent. However, in doing this, the work life, or time in which the material can be applied, is also reduced. If the work life is too short, the adhesive may be wasted, and the mating parts may not be properly adhered to each other. If the time to when the part can be handled, fixture time, is two long, repair or production time can be lost.

Thus, there exists a need for a structural adhesive formulation which can be used to increase the work life while mitigating the extension of fixture time.

### SUMMARY OF THE INVENTION

A curable two-part acrylate or methacrylate based structural adhesive composition for bonding a variety of substrates is provided that has an adhesive part A and an activator part B. The part A includes an amount of an acrylate or methacrylate ester monomer, a crosslinker amount of a polyfunctional monomer, an anti-oxidant, an adhesion promoter system to improve cured adhesive strength to a substrate, a free-radical polymerization initiator, and a first impact modifier. The activator part B includes an activator monomer amount of said methacrylate ester monomer(s), a second impact modifier, a free-radical polymerization accelerator, and a free radical polymerization initiator reducing agent. Each of the part A and the part B having a separate storage stability of at least 165 days at 23° C. An additive is present to modify working time that has limited effect on fixture time, the additive being at least one of: a sulfonyl chloride in Part A, an encapsulated sulfonyl chloride in Part B, a halogen transfer agent in Part B, a multifunctional chain transfer agent in Part B, or a combination of any of the afore mentioned.

A process of applying an adhesive to a substrate is provided that includes combining together the parts A and B to form an adhesive mixture with each of the two parts having storage stability at 23° C. for 165 days, such that viscosity after 165 days is within 100% of an initial viscosity. The adhesive mixture is then applied to the substrate and allowed to cure. The purpose of this document is to define a method to minimize the time between work life and fixture time.

### DETAILED DESCRIPTION OF THE INVENTION

The present invention has utility as a curing adhesive particularly well suited for bonding structural substrates. Structural substrates operatively bonded by an inventive adhesive may include electrogalvanized steel, hot-dipped galvanized steel, cold-rolled steel, aluminum, aluminum alloys, polyacrylonitrilebutadiene-styrene (ABS), mild steel (MS), polyvinyl chloride (PVC), and fiberglass. An inventive adhesive formulation is appreciated to be operative to bond to like structural substrates, as well as to bond one such substrate to other substrates including other metals, other plastics, and to do so through a rapid handling strength during cure to facilitate handling and removal of fixturing devices in a manufacturing setting.

This present invention achieves the seemingly contradictory characteristics of increasing the work life while mitigating the extension of fixture time through resort to the use of a transfer agent, an induction delaying agent, or a combination thereof. Without intending to be bound to a particular theory through agent selection the fixture time and work time properties are believed to be a result of a combination of thermodynamically and kinetically controlled processes.

An inventive formulation is provided as a two-part formulation that includes an adhesive part that is synonymously referred to herein as part A. The adhesive part of the formulation includes a polymerizable monomer component, elastic material, reacts with an activator part that is synonymously referred to herein as part B. The part B includes a rubber component and a polymerization accelerator. The following components of an inventive formulation are detailed as weight percentages of a formulated part A or part B inclusive of all components except non-reactive diluents, and non-reactive components under cure conditions illustratively including curing agents, corrosion inhibitors, chain transfer agents, induction agents, pigments, spacers, fragrances, fillers, and fire retardants. While the present invention is detailed herein with respect to a 1:1 by weight ratio mixture of Part A: Part B, it is appreciated that other mix ratios are readily compounded ranging from 20-1:1 Part A: Part B without departing from the spirit of the present invention.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

For the purpose of definition and defining a strength that is considered adequate for most production assemblies, fixture time as used herein is the time to reach the strength of 1000 pounds per square inch as measured per ASTM D1002 with a one-inch overlap using a bond gap of 0.03 inches.

As used herein, work life is defined as the time for the material to reach a state of gel as defined by a point in time after the material is first mixed when the storage modulus (G′) and the loss modulus (G″) are equal as defined by ASTM D7271.

This invention uses an acrylic adhesive in a two-part adhesive formulation. It is provided as a binary system consisting of an adhesive part A and an activator part B. The part A includes a monomer amount of an acrylate or methacrylate ester monomer, a crosslinker amount of a di, tri, or polyfunctional monomer, an anti-oxidant, a free-radical polymerization inhibitor, an adhesion promoter system, an impact modifier and a toughening agent, and a free-radical polymerization initiator. The part B includes an impact modifier, butyl rubber, methacrylate ester monomer, a crosslinker amount of a di, tri, or polyfunctional monomer, an anti-oxidant, coordination complex transition metal catalyst free-radical polymerization accelerator, and a reducing agent. The amount of Part B varies in the weight ratio used relative to part A. Each of the part A and the part B has separate storage stabilities of at least 165 days at 23° Celsius. A process of applying an adhesive to a substrate is provided that includes combining together parts A and B to form an adhesive mixture and applying the mixture to the substrate and allowing the applied mixture to cure.

In some inventive embodiments, Part B includes a halogen transfer agent of iodine, bromine, or a combination thereof. Without intending to be bound to a particular theory, free radicals associated with the cure process react with iodine or bromine to induce addition of a finite number of monomers before reacting to form the iodinated or brominated transfer agents in situ so as to create inhibition periods and polymerization periods, when the free radicals extending growing polymer chains and thereby create the cure rate without limited effect on fixture time. Typical loading of a halogen transfer agent, if present, range from 0.005 to 4 total weight percent of a combined Part A and Part B.

In some inventive embodiments, Part B includes a multifunctional chain transfer agent. It is appreciated that monofunctional chain transfer agents have routinely been used in the prior art. In the present invention, it has been found that that through resort to multifunctional chain transfer agents that are d-, tri-, tetra-, or polyfunctional, that the working time properties can be modified with minimal change in fixture time. Multifunctional chain transfer agents operative herein illustratively include: thiurams, dithiocarbarumates, dipentene dimercaptan, 2-mercapto ethanol, ethylene glycol dimercapto-acetate, trimethylolethane trithioglycolate, pentaerythritol tetrathioglycolate, pentaerythritol tetrakis(3-mercaptopropionate), trimethylolpropane tris(3-mercaptopropionate), 2,2′-(ethylenedioxy)diethanethiol, 1,8-dimercapto-3,6-dioxaoctane, 2-hydroxymethyl-2-methyl-1,3-propandiol tris-(3-mercaptopropionate). Some other examples are given in: Polymer Chemistry, 141, 2015, 6, 7333-7341). Typical loadings of a chain transfer agent in an inventive formulation are from 0 to 4 total weight percent of a fully formulated adhesive and function to regulate the length of the polymer chains. It is appreciated that the multifunctional chain transfer agents can be used in combination with halogen chain transfer agents, and/or sulfonyl chlorides to adjust work time of the resulting formulation.

In other inventive embodiments, an induction agent is provided that is a sulfonyl chloride. Sulfonyl chlorides operative herein illustratively include chlorosulfonated polyethylene, tosyl chloride, methanesulfonyl chloride, benzenesulfonyl chloride, C₂-C₁₄ alkylsulfonyl chloride, and C₇-C₁₄ arylsulfonyl chloride, or a combination thereof, where an alkyl is intended to include linear, branched, cyclic, structures, as well as the aforementioned structures with pendant groups therefrom, while aryl groups include diaryls and monoaryls inclusive of pendant groups. A sulfonyl chloride is present in the present invention in Part A in either unprotected or encapsulated form, while a sulfonyl chloride is present in Part B only in encapsulated form. Typical loading of a sulfonyl chloride, if present, ranges from 0.1 to 3 total weight percent of a combined Part A and Part B, not inclusive of any encapsulant. It is appreciated that the sulfonyl chlorides can be used in combination with halogen chain transfer agents, and/or multifunctional chain transfer agents to adjust work time of the resulting formulation.

An encapsulant operative herein is detailed in U.S. Pat. No. 3,396,116, the details of which are hereby incorporated by reference.

The adhesive Part A includes, in embodiments, a majority by active weight percent of acrylate monomer, methacrylate monomer, or a combination thereof. In other embodiments of the present invention, such monomers represent at least 20 weight percent of an adhesive Part A (exclusive of non-reactive diluents). Acrylate monomers and methacrylate monomers operative in the present invention illustratively include methylmethacrylate, C₁ to C₁₆ alkylacrylate, C₁ to C₁₆ alkyl methacrylate, C₁ to C₁₆ hydroxyl alkylacrylates, C₁ to C₁₆ amine acrylates, C₁ to C₁₆ secondary amine acrylates, C₁ to C₁₆ acrylosulfonic acids, and epoxy C₁ to C₁₆ acrylates or methacrylates. Specific acrylate and methacrylate monomers operative herein in addition to aforementioned methylmethacrylate include acrylate or methacrylate ester monomer is at least one of methyl(metha)crylate, ethyl(meth)acrylate, isobornyl (meth)acrylate, butyl(meth)acrylate, octyl(meth)acrylate, ethyl hexyl (meth)acrylates, dodecyl (meth)acrylate, tetrahydrofurfuryl (meth)acrylate, stearyl (meth)acrylate, lauryl (meth)acrylate, 2-phenoxyethyl (meth)acrylate, methoxy polyethylene glycol mono (meth)acrylate, isodecyl (meth)acrylate, cyclic trimethylolpropane formal (meth)acrylate, trimethylcyclohexyl (meth)acrylate, caprolactone (meth)acrylate, tridecy (meth)acrylate, cyclohexyl (meth)acrylate, 2-hydroxyl ethylacrylate, 2-hydroxyl (meth)acrylate, 3-hydroxyl propylacrylate, 1-hydroxyl-2 amino propylmethacrylate, 1-amino-2-hydroxyl propyl methacrylate, acrylamide, 1-amino-3-hydroxy propyl (meth)acrylate, 2-terbutyl amino ethyl (meth)acrylate, 2-acrylamido-2-methyl propane sulfonic acid, and glycidyl methacrylate or a combination thereof. An inventive formulation may also include a di-acrylate or methacrylate monomer, a tri-acrylate or methacrylate, tetra-methacrylate, penta-functional acrylate or methacrylate or higher functionality acrylate or methacrylate and carboxylic acid analogs thereof, or a combination thereof. These are synonymously referred to herein as polyfunctional monomers and illustratively a di-, tri-, tetra, penta, or higher functionality (meth)acrylate monomers, such as those selected from polyethylene glycol di(meth)acrylates, bisphenol-A di(meth)acrylates, tetrahydrofurane di(meth)acrylates, hexanediol di(meth)acrylates, polythylene glycol di(meth)acrylates, such as triethylene glycol di(meth)acrylate, tripropylene glycol di(meth)acrylate, tetraethylene glycol di(meth)acrylate, diethylene glycol di(meth)acrylate, 1,4-butanediol di(meth)acrylate, 1,6-hexanediol di(meth)acrylate, pentaerythritol tetra(meth)acrylate, trimethylol propane tri(meth)acrylate, trimethylol propane tri(meth)acrylate, dipentaerythritolmonohydroxypenta(meth)acrylate, pentaerythritol tri(meth)acrylate, ethoxylated bisphenol-A di(meth)acrylate, ethoxylatedtrimethylol propane tri(meth)acrylates, trimethylolpropanepropoxylate tri(meth)acrylates, or combinations thereof; and other such as detailed in U.S. Pat. Nos. 7,408,012; and 5,376,746, which are hereby incorporated by reference. In those embodiments of the present invention containing polyfunctional monomers, the polyfunctional monomer is typically present on a mole ratio relative to the aforementioned acrylate monomers of 0.00-0.5:1 with the ratio modifying the average chain length between cross linkages. It is appreciated that the (meth)acrylate ester polyfunctional monomer is present solely in adhesive part A in some embodiments while in other embodiments (meth)acrylate ester monomer is present in both parts A and B of an inventive formulation.

An inventive formulation in some embodiments includes a quantity of a neoprene, butadiene, acrylonitrile butadiene, or butyl rubber component. Without intending to be bound to a particular theory, it is believed that crack propagation of a cured inventive adhesive is inhibited by the presence of such rubber domains thereby changing the failure mode of the resultant adhesive.

As used herein, the term butyl rubber is intended to encompass SB rubber, isoprene rubber, polyisobutylene rubber, isobutylene Isoprene rubber, and combinations thereof. An impact modifier operative herein illustratively includes methacrylate butadiene styrene, nitrile rubber, a block copolymer of styrene or alpha methyl styrene and butadiene or hydrogenated butadiene, with high rubber graft having 50 percent rubber, ABS, natural rubber, and combinations thereof. The loading of an impact modifier depends on factors including weight ratio between adhesive part and activator part, impact modifier molecular weight, and impact modifier modulus.

Typical impact modifier loadings in adhesive:activator weight ratio formulation range from 12 to 50 total weight percent for a 1:1 (Part A: Part B volume/volume) ratio inventive formulation, when present. In certain inventive embodiments, a butyl rubber is present as a rubber component in combination with the impact modifier. In still other embodiments, the butyl rubber is segregated into an activator, part B of an inventive formulation, yet still serves to modify the failure mode of the cured adhesive.

An inventive formulation also includes a toughening agent. A toughening agent is distinguished from rubber component in the present invention in having low Tg and can significantly improve the performance of cured adhesives at low temperatures such as −40° F. (−40° C.) and at the same time does not cause a negative impact on the performance of cured adhesives at elevated temperatures such as 180° F. whereas the rubber component used in this invention are the core-shell structured impact modifiers and provide not only excellent impact strength but also non-sag, excellent thixotropic property and improved antisliding performance. Toughening agents operative herein illustratively can be chosen from a wide variety of elastomeric materials that form discrete particles or biphasic domains in a continuous resin matrix. For example, pre-reacted particles of polyacrylate, styrene/ethylene/styrene, alpha-methyl styrene/ethylene/alpha methyl styrene, alpha-methyl styrene/butadiene/alpha methyl styrene, styrene/butadiene/styrene (SBS) copolymers, styrene/isoprene/styrene (SIS) copolymers, styrene/butadiene (SBR) copolymers, as well as other pre-reacted materials may be added in particulate form to the resin composition. A partial listing of useful pre-reacted elastomer rubbers includes pre-reacted elastomer particles selected from the group consisting of acrylatebutadiene, butadiene, chloroprene, ethylene-propylene, ethylene-propylene-diene, isoprene, isobutylene, isobutylene isoprene (butyl rubber), styrene-butadiene, styrene-isoprene, acrylonitrile-butadiene, acrylonitrile-chloroprene, vinylpyridine-butadiene, vinylpyridine-styrene-butadiene, carboxylic-styrenebutadiene, chloro-isobutylene-isoprene (chlorobutyl rubber), bromo-isobutylene-isoprene (bromobutyl rubber), dialkysiloxane, polypropylene oxide), polyester urethanes, polyether urethanes, and mixtures thereof. Moreover, reactive liquid polymers (RLP's) also can be incorporated as the toughening component. RLP's contain functional groups, usually on their terminal ends but occasionally as pendant groups, and react with the resin in situ to form elastomeric domains. Examples of RLP's include, without limitation, vinyl terminated acrylonitrile butadiene (VTBN), carboxylterminated butadiene acrylonitrile (CTBN), amine-terminated butadiene acrylonitrile (ATBN), hydroxyl-terminated butadiene acrylonitrile (HTBN), epoxy-terminated butadiene acrylonitrile (ETBN), mercapto-terminated butadiene acrylonitrile (MTPN), and phenoxy-terminated butadiene acrylonitrile (PTBN). In specific embodiments of the present invention, the toughening agent includes chloro-sulphonated polyethylene, neoprene, copolymers of ethylene acrylic elastomer, poly (methyl methacrylate)-grafted rubber, butadiene styrene acrylonitrile copolymer or combinations thereof. It is appreciated that a toughening agent is present as a component of an adhesive part, an activator part, or both parts of an inventive formulation. In specific embodiments of the present invention, a toughening agent is present only in an adhesive part but it is appreciated that the amount of toughening agent present depends on characteristics of the toughening agent as well as the weight ratio between adhesive:activator parts, typical loadings of toughening agent in a fully formulated inventive adhesive range from 10-40 total weight percent in a 1:1 by volume, adhesive:activator formulation, when present. It is appreciated that inventive formulations are prepared that lack toughening agents and as such have them outside of the typical ranges.

In order to formulate an inventive adhesive formulation that achieves high strength without the need for a separate surface treatment prior to application of an inventive formulation, an adhesion promoter system is provided within an inventive formulation. The adhesion promoter system includes an etching agent and an adhesion promoter to facilitate adhesion of a fully cured formulation of various substrates including galvanized substrates. An adhesion promoter system is readily formulated into either an adhesive part, an activator part, or both parts of an inventive formulation. In specific embodiments, the adhesion promoter system is found only in the adhesive part. Specific adhesion promoters operated in an inventive formulation illustratively include a phosphate ester, a monofunctional phosphate, a difunctional phosphate, polymeric phosphate functionalized polymer, an acrylic acid, methacrylic acid, polymeric material with organic acid functionality, maleic acid, maleic acid functionalized polymer such a malenized polybutadiene, or a combination thereof. Typical loadings of adhesion promoter in an inventive formulation are from 1 to 15 total weight percent of a fully formulated adhesive with the amount being largely independent of the weight ratio between adhesive part:activator part.

Etching agents operative herein illustratively include inorganic acids such as sulfuric acid, nitric acid, hydrofluoric acid, hydrochloric acid, hydrobromic acid, perchloric acid, phosphoric acid, or monophosphate; and organic acids such as acetic acid, tannic acid or formic acid. Typical loadings of etching agent in an inventive formulation are from 0 to 2 total weight percent of a fully formulated adhesive with the amount being largely independent of the weight ratio between adhesive part:activator part.

A polymerization initiator present in an adhesive Part A is limited only by the desired kinetics of free-radical polymerization desired and compatibility with other inventive composition components. Initiators operative herein illustratively include tert-Butyl peroxylbenzoate, cumene hydroperoxide, tert-butyl hydroperoxide, and benzoyl peroxide combinations thereof. Typical loadings of an initiator in an inventive formulation are from 0.0001 to 4 total weight percent of a fully formulated adhesive.

A polymerization accelerator present in an activator Part B is limited only by the desired kinetics of free radical polymerization desired and compatibility with other inventive composition components. Accelerators operative herein illustratively include tert-pyridine derivatives, butaraldehyde aniline condensate, N,Ndimethylaniline, N,N-dimethyltoludiene, N,N-diethyltoludiene, copper acetyl acetonate (metal acetylacetonates), and combinations thereof. Typical loading of an accelerator in an inventive formulation is from 1 to 10 total weight percent of a fully formulated adhesive.

An inventive formulation in certain embodiments also includes various chelating agents, corrosion inhibitors, pigments, spacers, fragrances, fillers, fire retardants, and combinations thereof. Such additives are limited only by the requirement of compatibility with the other components of an inventive formulation. Such additives are provided to balance or otherwise modify at least one property of an inventive formulation as to handling, storage, cure rate, or adhesive properties.

An inventive formulation in certain embodiments also includes various oxidizing agents, reducing agents, thickeners, pigments, thixotropic agents, plasticizers, antioxidants, fillers, and combinations thereof. Such additives are limited only by the requirement of compatibility with the other components of an inventive formulation. Such additives are provided to balance or otherwise modify at least one property of an inventive formulation as to handling, storage, cure rate, or adhesive properties. Typical component amounts for an inventive adhesive are provided in Tables 1A and 1B for parts A and B, respectively.

Tables 1A and 1B. Typical Component Amounts for Adhesive (Part A) and Activator (Part B), Table 1A, where Amounts are given in weight percentages unless otherwise noted, with properties, Table 1B:

TABLE 1A
Adhesive (Part-A) and Activator (Part B) Component: (1:1 Ratio)

| | | Activator | Activator | Activator | Activator | Activator |
|---|---|---|---|---|---|---|
| | Part A | Formula | Formula | Formula | Formula | Formula |
| Ingredient | adhesive | B1 | B2 | B3 | B4 | B5 |
| Acrylic Ester | 42 to | 60 to | 60 to | 60 to | 60 to | 60 to |
| Monomer | remainder | remainder | remainder | remainder | remainder | remainder |
| Antioxidant | 1-2 | 1-2 | 1-2 | 1-2 | 1-2 | 1-2 |
| Sulfonyl chloride | 0-3 | — | — | — | — | — |
| Adhesion Promoter | 3 to 9 | — | — | — | — | — |
| Toughening agent | 12-20 | 5-15 | 5-15 | 5-15 | 5-15 | 5-15 |
| Polyfunctional | 0 to 4 | 0 to 4 | 0 to 4 | 0 to 4 | 0 to 4 | 0 to 4 |
| Monomer | | | | | | |
| Initiator | 1 to 5 | — | — | — | — | — |
| Additives | 1 to 2 | 2 to 4 | 2 to 4 | 2 to 4 | 2 to 4 | 2 to 4 |
| Impact Modifier | 14 to 20 | 5-15 | 5-15 | 5-15 | 5-15 | 5-15 |
| Accelerator | 0 to 1 | 1-5 | 1-5 | 1-5 | 1-5 | 1-5 |
| Thixotropic Agent | 1 to 2 | 1 to 2 | 1 to 2 | 1 to 2 | 1 to 2 | 1 to 2 |
| Monofunctional | — | — | 0-4 | — | — | — |
| Chain Transfer | | | | | | |
| Agent | | | | | | |
| Difunctional Chain | — | — | — | 0-4 | — | — |
| Transfer Agent | | | | | | |
| TetraFunctional | — | — | — | — | 0-4 | — |
| Chain Transfer | | | | | | |
| Agent | | | | | | |
| Halogen Transfer | — | — | — | — | — | 0-4 |
| Agent | | | | | | |

TABLE 1B
When Adhesive Part a is mixed at a 1:1 ratio by volume with Part
B1 through B5 above the properties below are produced.

| | | Adhesive | Adhesive | Adhesive | Adhesive | Adhesive |
|---|---|---|---|---|---|---|
| | | A with | A with | A with | A with | A with |
| Prop- | | Activator | Activator | Activator | Activator | Activator |
| erty | | B1 | B2 | B3 | B4 | B5 |
| Work | — | 45 | 41 | 40 | 40 | 45 |
| Life at | | | | | | |
| 75° F. | | | | | | |
| Fixture | — | 400 | 340 | 230 | 150 | 150 |
| Time at | | | | | | |
| 75° F. | | | | | | |
| (min) | | | | | | |

A process is provided for producing an adhesive formulation produced by free radical polymerization that bonds well to the aforementioned substrates. An inventive formulation is a two-part formulation that is either premixed to initiate a time period pot life, or alternatively the two parts are co-applied to a substrate under conditions for polymerization to occur between the various monomers. In specific inventive embodiments, polymerization occurs at 24° C. in ambient atmosphere on other embodiments, polymerization is initiated by energy inputs such as heating, ultraviolet radiation exposure or other free radical formation mechanisms. In certain inventive embodiments in which the adhesive part A, and activator part B are present in a 1:1 volumetric ratio ±10%, storage stability of more than 165 days at 23° C. is obtained.

Regardless of the form of an inventive formulation, upon induction of pot life for the formulation, the formulation is present in simultaneous contact with two or more substrates with the substrates held in contact with the curing inventive formulation for an amount of time sufficient to achieve a bond between the substrates. An inventive formulation is well-suited for bonding galvanized substrates, cold rolled steel, aluminum, PVC, ABS, mild steel, vinyl polymers, wood, and fiberglass. Two such substrates can be brought together to form various adjoined structures such as a lap joint, butt joint, corner joint, edge joint, and T-joint. In still other embodiments, an inventive formulation is applied to a single substrate and allowed to cure to form a coating that offers substrate protection or is operative as a primer for subsequent material applications. As an inventive formulation cures through a free radical mechanism, an inventive formulation can be applied to a variety of thicknesses and still achieve polymerization throughout. Typical thicknesses of an inventive formulation between substrates range from 0.001-25 mm.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient roadmap for implementing the exemplary embodiment or exemplary embodiments. It should be understood that various changes may be made in the function and arrangement of elements without departing from the scope as set forth in the appended claims and the legal equivalents thereof.

1. A curable two-part acrylate or methacrylate based structural adhesive composition for bonding a variety of substrates comprising:
an adhesive part A comprising: an amount of an acrylate or methacrylate ester monomer, a crosslinker amount of a polyfunctional monomer; an anti-oxidant; an adhesion promoter system to improve cured adhesive strength to a substrate; a free-radical polymerization initiator; and a first impact modifier; and
an activator part B comprising: an activator monomer amount of said methacrylate ester monomer(s); a second impact modifier; a free-radical polymerization accelerator, a free radical polymerization initiator reducing agent;
wherein each of said part A and said part B have a separate storage stability of at least 160 days at 23° C.,
wherein an additive is present to modify working time that has limited effect on fixture time, the additive being at least one of: a sulfonyl chloride in Part A, an encapsulated sulfonyl chloride in Part B, a halogen transfer agent in Part B, a multifunctional chain transfer agent in Part B, or a combination of any of the aforementioned.

2. The composition of claim 1 wherein said methacrylate ester monomer constitutes 25 to 75 percent by weight of the adhesive part A formulation.

3. The composition of claim 1 wherein said polyfunctional monomer and said methacrylate ester monomer are present in a molar ratio of 0.00-0.50:1.

4. The composition of claim 1 wherein said sulfonyl chloride is at least one of chlorosulfonated polyethylene, tosyl chloride, methanesulfonyl chloride, benzenesulfonyl chloride, C₂-C₁₄ alkylsulfonyl chloride, and C₇-C₁₄ arylsulfonyl chloride, or a combination thereof.

5. The composition of claim 1 wherein said first impact modifier and said second impact modifier are each independently at least one of methacrylate butadiene styrene, nitrile rubber, a block copolymer of styrene and butadiene, high rubber graft, or a combination thereof.

6. The composition of claim 1 further comprising a toughening agent of at least one of copolymers of ethylene acrylic elastomer, chloro-sulphonated polyethylene of poly (methyl methacrylate) grafted rubber, neoprene, styrene acrylonitrile copolymer, or a combination thereof.

7. The composition of claim 1 wherein said acrylate or methacrylate ester monomer is at least one of methyl(metha)crylate, ethyl(meth)acrylate, isobornyl (meth)acrylate, butyl(meth)acrylate, octyl(meth)acrylate, ethyl hexyl (meth)acrylates, dodecyl (meth)acrylate, tetrahydrofurfuryl (meth)acrylate, stearyl (meth)acrylate, lauryl (meth)acrylate, 2-phenoxyethyl (meth)acrylate, methoxy polyethylene glycol mono (meth)acrylate, isodecyl (meth)acrylate, cyclic trimethylolpropane formal (meth)acrylate, trimethylcyclohexyl (meth)acrylate, caprolactone (meth)acrylate, tridecy (meth)acrylate, cyclohexyl (meth)acrylate, 2-hydroxyl ethylacrylate, 2-hydroxyl (meth)acrylate, 3-hydroxyl propylacrylate, 1-hydroxyl-2 amino propylmethacrylate, 1-amino-2-hydroxyl propyl methacrylate, acrylamide, 1-amino-3-hydroxy propyl (meth)acrylate, 2-terbutyl amino ethyl (meth)acrylate, 2-acrylamido-2-methyl propane sulfonic acid, and glycidyl methacrylate or a combination thereof.

8. The composition of claim 1 wherein said adhesion promoter system comprises an adhesion promoter of a phosphate ester, a monofunctional phosphate, a difunctional phosphate, an acrylic acid, methacrylic acid, polymeric material with organic acid or phosphate functionality, maleic acid, maleic acid functionalized polymer such a maleinized polybutadiene, or a combination thereof.

9. The composition of claim 1 wherein said multifunctional chain transfer agent is present in part B.

10. The composition of claim 9 wherein said multifunctional chain transfer agent is difunctional.

11. The composition of claim 9 wherein said multifunctional chain transfer agent is at least one of a polysulfide resins; a di-, tri-, tetra-, or pental-functional mercaptan, or thiol functional multi-arm acrylate or methacrylate, or a combination thereof.

12. The composition of claim 1 wherein said halogen transfer agent is present in part B.

13. The composition of claim 1 wherein said sulfonyl chloride is present.

14. The composition of claim 1 wherein said activator part B further comprises a thixotropic agent.

15. The composition of claim 1 further comprising at least one of a chelating agent, corrosion inhibitor, pigment, spacer, fragrance, reinforcement, filler, fire retardant, plasticizer, or diluent.

16. The composition of claim 1 wherein said methacrylate ester monomer constitutes 35 to 75 percent by weight of the adhesive part A formulation.

17. A process of applying an adhesive to a substrate comprising: mixing together the components of claim 1 as a two-part formulation wherein each of said two parts has storage stability at 23° C. for 165 days, such that viscosity for after 165 days is within 100% of an initial viscosity; combining together said two parts to form an adhesive mixture; applying said adhesive mixture to the substrate; and allowing said adhesive mixture to cure.

18. The process of claim 17 wherein the volume ratio of adhesive part A to activator part B is 20-1:1±0.10%.

19. The process of claim 17 further comprising contacting a second substrate with said mixture during cure to create a bond between the substrate and the second substrate.

20. The process of claim 19 further comprising fixturing in a fixture the substrate and said second substrate in a joint position and in simultaneous contact with said mixture for a period of time between 5 and 180 minutes during the free-radical cure and then releasing the substrate and the second substrate from the fixture.
